(19) United States
(12) Patent Application Publication
(10) Pub. No.: US 2014/0200800 A1
(43) Pub. Date: Jul. 17, 2014

(54) METHOD AND DEVICE FOR DETERMINING A SUITABILITY OF A ROUTE

(71) Applicant: Andreas Vogel, Hildesheim (DE)

(72) Inventor: Andreas Vogel, Hildesheim (DE)

(21) Appl. No.: 14/129,046

(22) PCT Filed: May 14, 2012
(86) PCT No.: PCT/EP2012/058902

§ 371 Date: Mar. 27, 2014

(30) Foreign Application Priority Data
Jun. 22, 2011 (DE) 10 2011 077 941.8

(51) Int. Cl. G01C 21/34

(52) U.S. Cl. CPC G01C 21/3492
USPC 701/400

(57) ABSTRACT

A method for determining a suitability of a route including a plurality of sections for traveling on by a driver of a vehicle. The method has a step of determining a fatigue prediction value, which predicts a fatigue of the driver of the vehicle for at least one section of the route. The method also has a step of carrying out a comparison of the fatigue prediction value to a maximum fatigue value that is assigned to the at least one section of the route. Finally, the method has a step of weighting the route with a fatigue weighting that is a function of the comparison, in order to determine the suitability of the route for traveling on by the driver.

### FIELD

The present invention relates to a method and a device for determining a suitability of a route including a plurality of sections for traveling on by a driver of a vehicle, as well as a corresponding computer program product.

### BACKGROUND INFORMATION

The fatigue of the driver may be observed by various methods. The current state of fatigue is able to be displayed to the driver. If it is detected that the driver is too tired, it is then pointed out that a rest would be in order. Rest stops or hotels may also be searched for. These methods only ascertain the present fatigue, and, as attentiveness drops off, they may suggest taking a rest, for example.

German Patent Application No. DE 10 255 544 A1 describes a motor vehicle assistance system having a fatigue prediction device for the prediction of a state of fatigue of a driver of a motor vehicle.

### SUMMARY

The present invention provides an example method for determining the suitability of a route including a plurality of sections for traveling on by a driver of a vehicle, a corresponding device which executes this method, and finally a corresponding computer program product.

The present invention is based on the realization that considerable advantages accrue if, during a qualification of a suitable route, it is able to be taken into account that a driver becomes increasingly fatigued with increasing travel time. In the form of a fatigue weighting, this may have an effect on the route planning in a navigation device, or the like, for example. The fatigue weighting, in this instance, is ascertainable as a function of a fatigue prediction value, which gives the fatigue of a driver to be expected, and a maximum fatigue value. Every specific traffic situation, such as a certain kind of road or a crossing may have a maximum fatigue value assigned to it. The route may now be selected in such a way, for example, that the driver is never more fatigued on the respective route section than the respective traffic situation would require. In other words, a route may be valued as being favorable, for instance, if the fatigue prediction value is less than the maximum fatigue value, i.e., the fatigue of the driver that is to be expected is less than a maximum fatigue recommended for a certain traffic situation.

An advantage of the present invention is that, because of taking into account the fatigue of the driver as an additional parameter during route planning, the travel safety is able to be improved. For this reason, the presence of the attentiveness and concentration of the driver reduced by fatigue is able to be avoided in demanding traffic situations that are detectable ahead of time. In addition, devices already present in a vehicle and methods for route planning and fatigue detection may be used, these being broadened, supplemented and/or combined otherwise and used. A route planning adapted to fatigue according to types of embodiment of the present invention is consequently connected with only minimal or no additional hardware expenditure. The advantages of the present invention come about from dealing, in the preliminary stages, with fatigue of the driver that is certain to appear, and organizing a route corresponding to the fatigue development. Thus, the route may be organized more simply the more fatigued the driver is.

The present invention provides an example method and an example device for determining a suitability of a route including a plurality of sections for traveling on by a driver of a vehicle, the example method having the following steps:

determining a fatigue prediction value, which predicts the fatigue of a driver of the vehicle for at least one section of the route;

carrying out a comparison of the fatigue prediction value using a maximum fatigue value assigned to the at least one section of the route; and

weighting the route using a fatigue weighting depending on the comparison, so as to determine the suitability of the route for traveling on by the driver.

By a vehicle, one may understand, in this case, a motor vehicle, particularly a road vehicle, such as a passenger car or a truck. A suitable system, such as a navigation system, a driver assistance system or another information system in the vehicle, with the aid of position finding and stored geographical data, enables navigating to a chosen location via a route, while observing desired criteria and requirements. The route may be composed of a number of sections. In the case of an individual section of a route, a route section of a certain length may be involved, a crossing, a road section within or outside of a closed community or the like being able to represent a section of a route. The fatigue prediction value may be determined by a suitable process for fatigue estimation. Thus, for example, the failure of steering motions to appear and a subsequent sudden correction point to fatigue. Using suitable monitoring devices, such as inside cameras, for example, one may estimate the current fatigue of the driver. The fatigue prediction value may vary from section to section, over the course of the road. A maximum fatigue value applies in each case for one section of the route, and gives a recommended upper limit of the fatigue of a driver for this section. From the comparison of the fatigue prediction value for the at least one section of the route with the maximum fatigue value valid for this section, the fatigue weighting comes about. The fatigue weighting may be a value or a factor which scales a suitability of the route for traveling on by the driver, particularly with respect to possible fatigue risks. The fatigue weighting offset with the route data may have the effect that the suitability of the route is neutral, increased or reduced. If, for example, the fatigue prediction value is greater than the maximum fatigue value, the weighting applies in such a way that the suitability is reduced. Steps of the method may be carried out by using a mathematical and/or logical linkage of data, based, for instance, on basic arithmetical operations, using a look-up table, using a statistical evaluation, or the like.

In the determining step, at least one additional fatigue prediction value may also be determined, which predicts a fatigue of the driver of the vehicle for at least one section of at least one further route, and in the step of carrying out the comparison of the at least one additional fatigue prediction value with the at least one additional maximum fatigue value assigned to the at least one section of the at least one additional route, and in the weighting step, the at least one additional route may be weighted with at least one additional fatigue weighting depending upon the comparison, in order to determine the suitability of the at least one further route for traveling on by the driver. This offers the advantage of a possible choice between a plurality of routes, whose suitability is certain and thus known. This may also turn out favorable, for example, if, based on usually used other optimization parameters or evaluation or selection criteria specified by the driver, no clearly most suitable route is found, or one or more alternative routes executed, to an original route are to be offered. This raises the flexibility of the route planning.

According to one specific embodiment, a selecting step may be provided of one of the routes as being suitable for traveling on by the driver, as a function of the fatigue weightings. In this case, from a plurality of routes whose suitability has been determined, a route is selected having a desired suitability. The desired suitability may be the best suitability or a suitability that is in harmony with other optimization parameters or evaluation criteria or selection criteria that are usually used and specified by a driver. The route selected may be output to the driver via a suitable output device, such as a display and/or a loudspeaker. Such a specific embodiment has the advantage that a favorable route corresponding to the predicted fatigue is able to be selected. Consequently, a reliable route selection may be made and danger conditioned upon fatigue may be avoided.

In the determining step, the fatigue prediction value may also be determined as a function of the time characteristic of the route. The time characteristic may include an expected time duration of the route, rests possibly provided and/or having taken place, a sequence in time of sections of the route and/or the like. The fatigue prediction value may be determined before travel of the route. The fatigue prediction value may also be determined repeatedly during the travel of the route. Repeated determination of the fatigue prediction value during travel of the route may have the effect of adjusting the fatigue prediction value. Thus, the fatigue prediction value may be lowered if, for example, the expected time duration of the route is abbreviated, a rest stop is inserted, or various sections of the route succeed one another at short distances in time. Such a specific embodiment has the advantage that an individual, accurate and current fatigue prediction value is able to be provided for the comparison with the maximum fatigue value.

According to one specific embodiment, a step of ascertaining the maximum fatigue value for the at least one section of the route may be provided.

This has the advantage that a maximum fatigue value ascertained individually for the section is able to be provided for the comparison with the fatigue prediction value.

As a result, the ascertained maximum fatigue value may be coordinated better with the section of the route, whereby the accuracy of determination of the suitability of the route is increased.

In this context, a determining step a traffic situation assigned to the section may be provided, and in the ascertaining step, a predetermined value assigned to the traffic situation being selected as the maximum fatigue value. The traffic situation may include conditions or a character of the section prevailing in the respective section, such as the type of road, crossing or the like to be traveled.

Data with respect to the constitution of the section may be provided using a suitable system, such as a navigation system, a driver assistance system or other information systems. The data are able to classify or characterize the condition of the section. From the data with respect to the condition of the section, the traffic situation assigned to the section may be determined. A predetermined value assigned to the traffic situation may be stored retrievably in a data base. The predetermined value in this case may, for instance, be retrievably stored in a route data base of the navigation system, driver assistance system or other information system, or in another memory internal or external to the vehicle. Such a specific embodiment has the advantage that the maximum fatigue value may be adjusted optimally to the respective section, and may be coordinated even more accurately with the respective traffic situation by taking into account the traffic situation in the section. This enables an even more improved determination accuracy of the suitability of the route.

In the ascertaining step, the maximum fatigue value for the at least one section of the route may also be ascertained with respect to the situation while using data at the time of the passing the at least one section of the route by the vehicle. In this case, the ascertaining step may be carried out, once or several times, before and/or during the traveling of the route. The point in time and the data may be calculated ahead of time, in this instance. The data may also include sensor signals of vehicle sensors or other information signals of systems internal or external to the vehicle. The data may, for instance, have vehicle position information, route course information, travel rest stop information, traffic density information, time information, weather information, road information and/or the like. Such a specific embodiment has the advantage of an ascertainment, coordinated optimally with the respective section of the route, of a maximum fatigue value as accurate and as current as possible. This is able to optimize the accuracy of the determination of the suitability even further.

According to one specific embodiment, in the determining step, in each case, a fatigue prediction value may be determined for each section of the route, and in the carrying out step, in each case a comparison may be carried out for each section of the route, and in the step of weighting, the route may be weighted using a fatigue weighting that is a function of the comparisons, in order to determine the suitability of the route for traveling on by the driver. This has the advantage that the determination of the suitability of the route is improved, since the route may be evaluated more accurately by taking into account all the sections of the route.

The present invention also provides an example device for determining a suitability of a route including a plurality of sections for traveling on by a driver of a vehicle, the example device having the following features:

a device to determine a fatigue prediction value, which predicts the fatigue of a driver of the vehicle for at least one section of the route;

a device to carry out a comparison of the fatigue prediction value using a maximum fatigue value assigned to the at least one section of the route; and

a device to weight the route using a fatigue weighting depending on the comparison, so as to determine the suitability of the route for traveling on by the driver.

In the case at hand, a device may be understood to be an electrical or an electronic device, which processes route data and fatigue data, and outputs a fatigue weighting and suitability information as a function thereof. The device may have an interface which may be developed along hardware and/or software lines. In a hardware-type development, the interfaces may, for instance, be a part of a so-called system ASIC, which includes the most varied functions of the device. However, it is also possible for the interfaces to be characteristic, integrated switching circuits or to be at least partially made up of discrete components. In a software development, the interfaces may be software modules which are present on a microcontroller, in addition to other software modules, for example. However, the device does not have to include the apparatus or not all the apparatus itself, but rather, data from units already installed in the vehicle may further be used for the present invention. The present invention also provides an example device that is developed to carry out or implement the steps of the example method according to the present invention. The example device may particularly have apparatus that is developed for each to carry out one step of the example method. This embodiment variant of the present invention in the form of a device may also be used quickly and efficiently.

An advantageous development also includes an example computer program product having program code that is stored on a machine-readable medium such as a semiconductor memory, a hard-disk memory or an optical memory, which is used to implement the example method according to one of the specific embodiments described above, when the program is executed on a device.

### BRIEF DESCRIPTION OF THE DRAWINGS

The present invention is explained in greater detail with reference to the figures.

FIG. 1 shows a block diagram of a vehicle in which an example device according to exemplary embodiments of the present invention is situated.

FIG. 2 shows a schematic representation of a plurality of routes including sections.

FIG. 3 shows a flow chart of a method according to one exemplary embodiment of the present invention.

### DETAILED DESCRIPTION OF EXAMPLE EMBODIMENTS

In the description below of preferred exemplary embodiments of the present invention, the same or similar reference numerals are used for the elements that are shown in the various figures and act similarly, so that a repeated description of these elements has been dispensed with.

FIG. 1 shows a block diagram of a vehicle in which a device according to an exemplary embodiment of the present invention is situated. What is shown is a vehicle 100, an information system 110 and a device 150. Information system 110 is connected to device 150. Even though it is not shown in FIG. 1, information system 110 and device 150 may be provided as one unit. Information system 110 may be a navigation system, a driver assistance system or the like, as is usual in vehicles. A route to be traveled may be indicated to the driver via the information system. Device 150 is a device for determining a suitability of a route including a plurality of sections for traveling on by a driver of a vehicle. Using device 150, a route to be traveled by the driver of the vehicle is able to be checked for suitability, namely with respect to a travel suitability or the fatigue of the driver. If a route is rated as suitable, it may be so indicated to the driver via information system 110. If, on the other hand, it is not rated as suitable, the indication of the route via information system 110 may be prevented, or the route may be provided with a warning.

According to this exemplary embodiment, device 150 has an apparatus 160 for determining, an apparatus 170 for carrying out a comparison and an apparatus 180 for weighting. Apparati 160, 170, 180 are interconnected. Apparatus 160 is developed to determine a fatigue prediction value, which predicts the fatigue of a driver of the vehicle for at least one section of the route. Apparatus 170 is developed for carrying out a comparison of the fatigue prediction value to a maximum fatigue value assigned to the at least one section of the route. Apparatus 180 is developed for weighting the route using a fatigue weighting that is a function of the comparison, in order to determine the suitability of the route for traveling on by the driver.

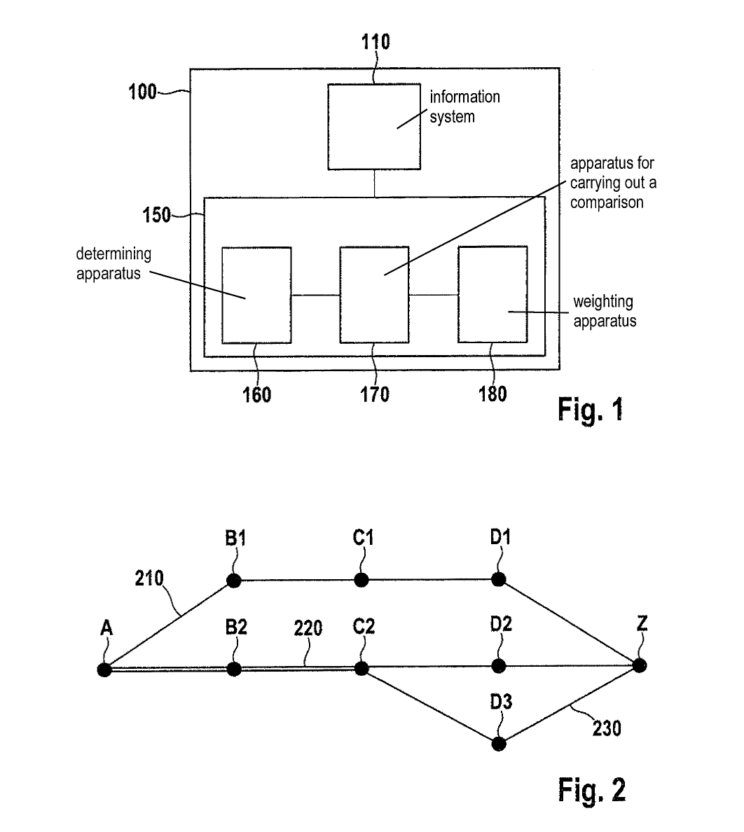

FIG. 2 shows a schematic representation of a plurality of routes including sections between a point A and a point Z. The routes are able to be traveled on by the driver. What is shown is a first route 210, a second route 220, a third route 230 and route points A, B1, B2, C1, C2, D1, D2, D3, Z. First route 210 runs from route point A via route point B1, C1, D1 to route point Z. Second route 220 runs from route point A via route points B2, C2 and D2 to route point Z. Third route 230 runs from route point A via route points B2, C2, D3 to route point Z. Route point A is able to represent a starting point of routes 210, 220, 230. Route point Z is able to represent a destination or end point of routes 210, 220, 230.

Each of route points A, B1, B2, C1, C2, D1, D2, D3, Z may represent a branching or crossing. Each route point A, B1, B2, C1, C2, D1, D2, D3, Z has a maximum fatigue value assigned to it. In each case, a segment is situated between every two adjacent route points A, B1, B2, C1, C2, D1, D2, D3, Z of a route 210, 220, 230. A maximum fatigue value is assigned to each segment. Each route point A, B1, B2, C1, C2, D1, D2, D3, Z and each segment thus form a section of a route 210, 220, 230, and to each section its own maximum fatigue value is assigned. The maximum fatigue value may be a function of a characteristic of the respective section that refers to the attentiveness of the driver. The maximum fatigue value may be determined independently of the driver.

Furthermore, for each section, a fatigue prediction value assigned to the driver may be determined. The fatigue prediction value may be a function, for instance, of the driving time of the driver up to the respective section already covered or to be covered. The fatigue prediction value may also be a function of the type of section already covered or sections to be covered, up to the respective section. The fatigue prediction value, in this case, may be increased at a fatiguing section to be passed, and decreased, in contrast, at a section having a pepping-up effect.

For each section, a comparison may be made between the maximum fatigue value of the section and the fatigue prediction value of the section. If the fatigue prediction value for a section of a route 210, 220, 230 is greater than the corresponding maximum fatigue value, the corresponding section may be provided with a weighting which rates the section as being unsuitable. If the maximum fatigue value for a section of a route 210, 220, 230 is less than the corresponding maximum fatigue value, the corresponding section may be provided with a weighting which rates the section as being suitable. Depending on the weightings of the individual sections of a route 210, 220, 230, route 210, 220, 230 may be weighted with a fatigue weighting which gives a suitability of the entire route 210, 220, 230 for traveling on by the driver.

The steps described are able to be carried out by device 150 shown in FIG. 1, for example. It may be determined using the device, that the suitability of route 210 is less than the suitability of route 220, for example. In this case, the suitability of route 210 may be lower in some or all sections than the suitability of route 220. The suitability of route 220 may, in turn, be lower than the suitability of route 230. In this context, the suitability of routes 220, 230 may be the same between route points A and C2. Between route points C2 and Z, in contrast, the suitability of route 220 may be lower than the suitability of route 230. Consequently, information system 110 shown in FIG. 1 is preferably able to propose route 230 for traveling on by the driver.

According to one exemplary embodiment, for each traffic situation, such as the type of road or crossing, an associated maximum fatigue value may be provided. The maximum fatigue value may be directly in the data, such as the route data, or it is calculated from the respective situation. The maximum fatigue value is very small for complex, inner-city crossings, for example, i.e., the driver has to be quite awake and attentive, in order to master this intersection without danger. For express highways, the maximum fatigue value may be somewhat higher, to be sure, and for country roads even higher. Besides that, the maximum fatigue value may vary with the time of day, for example. Thus, for example, at darkness a road may require more attentiveness than in daylight, and the maximum fatigue value may also be a function of the respective traffic volume. The maximum fatigue value may also be a function of the respective route up to now. Thus, for example, a long expressway drive fatigues a driver more than a short section on the expressway. If a driver has a fatigue prediction value in one section of the route, that is greater than a maximum fatigue value for a traffic situation, he should not travel the route in this section.

During a usual search of the route, which may be done, for instance, in a navigation system or other assistance system, starting from a starting point, various routes are tracked simultaneously, in the form of search paths in the destination direction, along different paths. The search path, which reaches the destination after the shortest time and/or shortest route or another optional optimization criterion, is usually used subsequently as the route. According to exemplary embodiments of the present invention, a fatigue parameter is also calculated for each search path or each route. In the simplest case, the parameter grows proportionally to the current travel duration up to the respectively current point, or, according to other methods for fatigue approximation. Now, if the current fatigue prediction value of a driver in a section of the route is greater than the maximum fatigue value for the section of the route to be traveled now, this route is not pursued further, for example, at least with respect to the respective section. This being the case, only such routes are able to reach the destination, for example, which only or predominantly travel along situations which the driver is also able to master, having in each case the current fatigue prediction value. With increasing travel duration, for example, ever more simple situations are preferred.

Instead of stopping a route right away when the current fatigue prediction value rises above the allowed maximum fatigue value, this search path may also receive a greater fatigue weighting. This is a favorable variant of the determination of the suitability of the route. In this case, to be sure, the fatigue weighting is fed into the route, but short paths through an inner city, for example, are not completely blocked, based on their low maximum fatigue value. By moderately feeding in these fatigue parameters, in the form of fatigue weightings, a search is thus made, for a simpler alternative route, for example. If there is no alternative route, however, the route having the high fatigue weighting is offered nevertheless.

Conventionally, it may be pointed out to a driver that he should take a rest. However, using the determination of the suitability of a route, according to exemplary embodiments of the present invention, reasons may be given as to why it is important to be alert. Complex situations in route sections ahead may be pointed out. It may also be indicated to the driver how the different routes, having fatigue as opposed to the rested state, run, in order to demonstrate the advantage of a rest. This may motivate the driver more to take a rest than just the comment that it is time for a rest.

If it is detected that a rest is being taken or that another driver is at the wheel, the current fatigue prediction value may be reduced, and this may result in a recalculation of the route after the rest.

There are also traffic situations tending to pep up the driver and make him more wide awake. As an example, we refer to the change from driving on the expressway to driving in the inner city. The driver becomes more awake again because of the changed environmental circumstances. After such situations, the fatigue prediction value may be reduced.

The determining of the suitability of a route, while taking fatigue into account, may be active continuously or may be activated from time to time. How greatly the fatigue weighting is supposed to have an effect on the course of the route may also be set. Stated more simply, complex traffic situations are avoided for far distant route sections. If a rest is taken, more complex situations may again be traveled in, which leads to a recalculation of the road. Then again, those locations, at which the maximum fatigue value is greater than the fatigue prediction value, are not completely blocked, for example, but are taken into account as additional fatigue weighting in the route calculation.

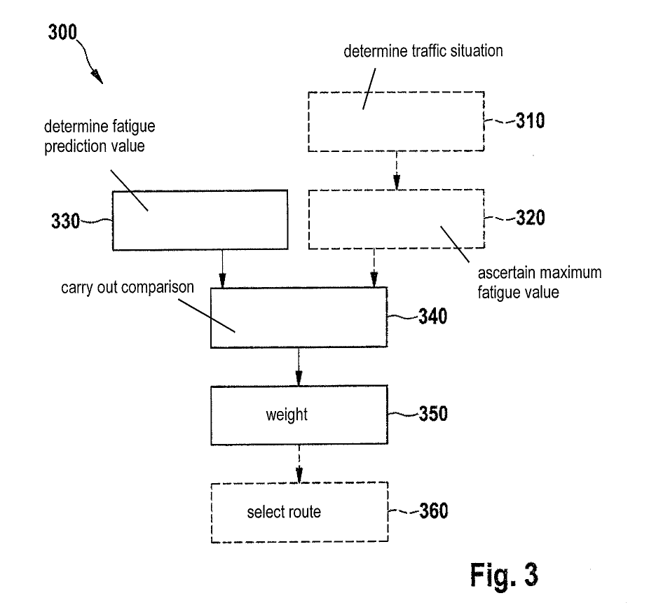

FIG. 3 shows a flow chart of an example method 300 for determining a suitability of a route including a plurality of sections for traveling on by a driver of a vehicle, according to one exemplary embodiment of the present invention. Method 300 has steps 310, 320, 330, 340, 350 and 360, steps 310, 320 and/or 360 being able to be optional. Method 300 may be carried out in connection with a device according to exemplary embodiments of the present invention, such as the device in FIG. 1.

Method 300 has a step of determining 330 a fatigue prediction value, which predicts the fatigue of a driver of the vehicle for at least one section of the route. Method 300 also has a step of carrying out 340 a comparison of the fatigue prediction value to a maximum fatigue value assigned to the at least one section of the route. Method 300 also has a weighting step 350 of the route with a fatigue weighting that is a function of the comparison, in order to determine the suitability of the route for traveling on by the driver.

In the determining step 330, the fatigue prediction value may be determined as a function of the time characteristic of the route. In the determining step 330, in each case, a fatigue prediction value may be determined for each section of the route, and in the step of carrying out 340, in each case a comparison may be carried out for each section of the route, and in the step of weighting 350, the route may be weighted using a fatigue weighting that is a function of the comparisons, in order to determine the suitability of the route for traveling on by the driver.

In the determining step 330, at least one additional fatigue prediction value may also be determined, which predicts a fatigue of the driver of the vehicle for at least one section of at least one further route, and in the step of carrying out 340 the comparison of the at least one additional fatigue prediction value with the at least one additional maximum fatigue value assigned to the at least one section of the at least one additional route, and in the weighting step 350, the at least one additional route may be weighted with the at least one additional fatigue weighting depending upon the comparison, in order to determine the suitability of the at least one further route for traveling on by the driver. Example method 300 then also has a selecting step 360 of one of the routes as being suitable for traveling on by the driver, as a function of the fatigue weightings.

Furthermore, example method 300 has a step of ascertaining 320 of the maximum fatigue value for the at least one section of the route. Example method 300 also has a step of determining 310 a traffic situation associated with the section, in which, in the step of ascertaining 320, a predetermined value, assigned to the traffic situation, is then able to be selected as the maximum fatigue value. In the ascertaining step 320 the maximum fatigue value for the at least one section of the route may also be ascertained with respect to the situation while using data at the time of the passing of the at least one section of the route by the vehicle.

The exemplary embodiments described and shown in the figures have been selected merely as examples. Different exemplary embodiments are combinable with one another, either completely or with regard to individual features. An exemplary embodiment may also be supplemented by features from another exemplary embodiment. Furthermore, method steps according to the present invention may be carried out repeatedly and also performed in a sequence other than the one described.

1-10. (canceled)

11. A method for determining a suitability of a route, including a plurality of sections, for traveling on by a driver of a vehicle, comprising:
determining a fatigue prediction value which predicts fatigue of a driver of the vehicle for at least one section of the route;
carrying out a comparison of the fatigue prediction value using a maximum fatigue value assigned to the at least one section of the route; and
weighting the route using a fatigue weighting that is a function of the comparison to determine suitability of the route for traveling on by the driver.

12. The method as recited in claim 11, wherein, in the determining step, at least one additional fatigue prediction value is determined which predicts a fatigue of the driver of the vehicle for at least one section of at least one further route, in the carrying out the comparison step, the at least one additional fatigue prediction value is compared to at least one additional maximum fatigue value assigned to the at least one section of the at least one additional route, and in the weighting step, the at least one additional route is weighted with at least one additional fatigue weighting that is a function of the comparison to determine the suitability of the at least one further route for traveling on by the driver.

13. The method as recited in claim 12, further comprising:
selecting one of the routes as being suitable for traveling on by the driver as a function of the fatigue weightings.

14. The method as recited in claim 11, wherein, in the determining step, the fatigue prediction value is determined as a function of a time characteristic of the route.

15. The method as recited in claim 11, further comprising:
ascertaining the maximum fatigue value for the at least one section of the route.

16. The method as recited in claim 15, further comprising:
determining a traffic situation associated with at least one section, wherein, in the ascertaining step, a predetermined value assigned to the traffic situation is selected as the maximum fatigue value.

17. The method as recited in claim 16, wherein, in the ascertaining step, the maximum fatigue value for the at least one section of the route is ascertained with respect to the situation while using data at a time of the passing of the at least one section of the route by the vehicle.

18. The method as recited in claim 11, wherein, in the determining step, in each case, a fatigue prediction value is determined for each section of the route, in the carrying out step, in each case a comparison is carried out for each section of the route, and in the weighting step, the route is weighted using a fatigue weighting that is a function of the comparisons, to determine the suitability of the route for traveling on by the driver.

19. A device for determining a suitability of a route including a plurality of sections for traveling on by a driver of a vehicle, comprising:
an apparatus to determine a fatigue prediction value which predicts the fatigue of the driver of the vehicle for at least one section of the route;
an apparatus to carry out a comparison of the fatigue prediction value to a maximum fatigue value assigned to the at least one section of the route; and
an apparatus to weight the route using a fatigue weighting that is a function of the comparison to determine the suitability of the route for traveling on by the driver.

20. A computer-readable storage medium storing program code to determine a suitability of a route, including a plurality of sections, for traveling on by a driver of a vehicle, the program code, when executed by a device, causing the device to perform the steps of:
determining a fatigue prediction value which predicts fatigue of a driver of the vehicle for at least one section of the route;
carrying out a comparison of the fatigue prediction value using a maximum fatigue value assigned to the at least one section of the route; and
weighting the route using a fatigue weighting that is a function of the comparison to determine suitability of the route for traveling on by the driver.
